(19) United States
(12) Patent Application Publication
(10) Pub. No.: US 2014/0207516 A1
(43) Pub. Date: Jul. 24, 2014

(54) Methods and Apparatus for Procurement

(71) Applicant: International Business Machines Corporation, Armonk, NY (US)

(72) Inventors: Pawan R. Chowdhary, Montrose, NY (US); Youssef Drissi, Ossining, NY (US); Kaan K. Katircioglu, Yorktown Heights, NY (US); Scott W. Pollyea, Loveland, CO (US)

(73) Assignee: International Business Machines Corporation, Armonk, NY (US)

(21) Appl. No.: 13/970,697

(22) Filed: Aug. 20, 2013

Related U.S. Application Data
(63) Continuation of application No. 13/745,964, filed on Jan. 21, 2013.

(51) Int. Cl. G06Q 30/02

(52) U.S. Cl. CPC G06Q 30/0201
USPC 705/7.29

(57) ABSTRACT

Systems and techniques for procurement of equipment and services are disclosed. Data is collected relating to operations of an organization and the information is made accessible to vendors who may supply goods and services for carrying out the operations. The collected data may include information relating to inputs of the operations, size, shape, and weight of objects handled in the operations, actual and desired throughput, energy use, waste, and other data. Data may be anonymized before being made accessible to vendors, and proposals made by vendors in response to data from a particular organization may be directed to the organization from which the data is collected.

### CROSS-REFERENCE TO RELATED APPLICATIONS

This patent application is a continuation of U.S. patent application Ser. No. 13/745,964, filed on Jan. 21, 2013. The patent application identified above is incorporated herein by reference in its entirety to provide continuity of disclosure.

### FIELD OF THE INVENTION

One or more embodiments of the present invention relate generally to procurement of goods and services. More particularly, embodiments of the invention relate to mechanisms by which an organization can make information accessible to providers of goods and services to be used in determining and proposing goods and services to meet needs of the organization that can be identified through analysis of the information.

### BACKGROUND

Organizations, particularly large organizations, use goods and services of all types to carry out their activities, such as manufacturing and handling goods, administration of their activities, and so on. Identification of a need for new or replacement goods can be a complex process, involving examining equipment needs, determining what products are available, soliciting proposals from vendors, and so on. Vendors then respond to the solicitations, proposing solutions based on the customer's description of his or her needs. Typically, the description of the organization's needs is based on an examination of the products available in the marketplace, and the customer solicits proposals from vendors that it can become aware of through its examination of the marketplace. In addition, vendors undertake marketing efforts to make potential customers aware of their products, and their efforts are limited to one degree or another by the cost of marketing and limits on the information that is available about which customers might need their products.

### SUMMARY

In one embodiment of the invention, a method comprises collecting data relating to carrying out an operation, wherein data is collected relating to at least one of inputs to and results of the operation, material usage of the operation, and waste produced by the operation and making the collected data accessible to one or more vendors providing at least one of products and services relating to carrying out the operation.

In another embodiment of the invention, a method comprises storing data collected from a plurality of organizations, data from each organization relating to carrying out at least one operation of the organization, wherein the data further relates to at least one of inputs to and results of the operation, material usage of the operation, and waste produced by the operation, separating the collected data relating to carrying out the at least one operation of the organization from identifying data identifying the organization, and making the collected data accessible to one or more vendors providing at least one of products and services relating to carrying out the operation.

In another embodiment of the invention, a method comprises collecting data relating to carrying out an operation, wherein data is collected relating to inputs to and outputs of the operation, energy usage of the operation, and carbon dioxide production of the operation. The collected data comprises data relating to characteristics of goods handled in the operation, and data relating to the characteristics of goods comprises data relating to at least one of weight, shape, and size of goods handled in the operation. The method further comprises assembling data into at least two groups, wherein each of the groups is associated with an aspect of the operation, and wherein the groups comprise at least one of data associated with supply chain management, data associated with product production, data associated with handling of goods, and data associated with transportation, and the method further comprises making the collected data accessible to at least one vendor providing at least one of products and services relating to carrying out the operation.

In another embodiment of the invention, an apparatus comprises at least one processor and memory storing computer program code. The memory storing the computer program code is configured to, with the at least one processor, cause the apparatus to at least collect data relating to carrying out an operation, wherein data is collected relating to at least one of inputs to and results of the operation, material usage of the operation, and waste produced by the operation and make the collected data accessible to one or more vendors providing at least one of products and services relating to carrying out the operation.

In another embodiment of the invention, an apparatus comprises at least one processor and memory storing computer program code. The memory storing the computer program code is configured to, with the at least one processor, cause the apparatus to at least store data collected from a plurality of organizations, data from each organization relating to carrying out at least one operation of the organization, wherein the data further relates to at least one of inputs to and results of the operation, material usage of the operation, and waste produced by the operation, separate the collected data relating to carrying out the at least one operation of the organization from identifying data identifying the organization, and make the collected data accessible to one or more vendors providing at least one of products and services relating to carrying out the operation.

In another embodiment of the invention, an apparatus comprises at least one processor and memory storing computer program code. The memory storing the computer program code is configured to, with the at least one processor, cause the apparatus to at least collect data relating to carrying out an operation, wherein data is collected relating to inputs to and outputs of the operation, energy usage of the operation, and carbon dioxide production of the operation. The collected data comprises data relating to characteristics of goods handled in the operation, and data relating to the characteristics of goods comprises data relating to at least one of weight, shape, and size of goods handled in the operation. The apparatus is further caused to assemble data into at least two groups, wherein each of the groups is associated with an aspect of the operation, and wherein the groups comprise at least one of data associated with supply chain management, data associated with product production, data associated with handling of goods, and data associated with transportation, and is further caused to make the collected data accessible to at least one vendor providing at least one of products and services relating to carrying out the operation.

In another embodiment of the invention, a computer readable medium stores a program of instructions. Execution of the program of instructions by a processor configures an apparatus to at least collect data relating to carrying out an operation, wherein data is collected relating to at least one of inputs to and results of the operation, material usage of the operation, and waste produced by the operation and make the collected data accessible to one or more vendors providing at least one of products and services relating to carrying out the operation.

In another embodiment of the invention, a computer readable medium stores a program of instructions. Execution of the program of instructions by a processor configures an apparatus to at least store data collected from a plurality of organizations, data from each organization relating to carrying out at least one operation of the organization, wherein the data further relates to at least one of inputs to and results of the operation, material usage of the operation, and waste produced by the operation, separate the collected data relating to carrying out the at least one operation of the organization from identifying data identifying the organization, and make the collected data accessible to one or more vendors providing at least one of products and services relating to carrying out the operation.

In another embodiment of the invention, a computer readable medium stores a program of instructions. Execution of the program of instructions by a processor configures an apparatus to at least collect data relating to carrying out an operation, wherein data is collected relating to inputs to and outputs of the operation, energy usage of the operation, and carbon dioxide production of the operation. The collected data comprises data relating to characteristics of goods handled in the operation, and data relating to the characteristics of goods comprises data relating to at least one of weight, shape, and size of goods handled in the operation. The apparatus is further configured to assemble data into at least two groups, wherein each of the groups is associated with an aspect of the operation, and wherein the groups comprise at least one of data associated with supply chain management, data associated with product production, data associated with handling of goods, and data associated with transportation, and make the collected data accessible to at least one vendor providing at least one of products and services relating to carrying out the operation.

### BRIEF DESCRIPTION OF THE SEVERAL VIEWS OF THE DRAWINGS

FIG. 1 illustrates a system according to an embodiment of the present invention;

FIG. 2 illustrates a process according to an embodiment of the present invention; and

FIG. 3 illustrates elements according to an embodiment of the present invention.

### DETAILED DESCRIPTION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the present invention recognize that the needs of an organization are not typically best understood not in terms of a need for particular goods or services. Rather, the needs of an organization are typically best understood in terms of the carrying out of the organization's activities. Numerous different combinations of goods, such as equipment, can be used to carry out an organization's activities, and numerous services can be used to assist in the carrying out of those activities.

Embodiments of the invention further recognize that an organization requiring goods and services likely does not have the fullest knowledge about the goods and services available; vendors will have more complete knowledge. Similarly, a supplier of goods or services does not have the fullest knowledge about the activities to be carried out by an organization using goods or services that may be obtained from the provider. In addition, a supplier, such as an equipment manufacturer, who is simply presented with equipment specifications or requirements may not be able to use its full insight into the benefits that may be able to be achieved using its equipment, and an organization may not even recognize that an equipment combination may be available that would improve its operations.

Various embodiments of the invention therefore provide mechanisms for an organization, herein referred to as a customer, to gather information relating to its operations and present such information to suppliers. Suppliers, using the information relating to the organization's operations, are able to analyze this information and determine if they can provide improvements, or, in the case of replacing equipment, can provide equipment providing at least equal benefits to those the customer is already receiving. A vendor need not even necessarily know what equipment the customer is currently using. Instead, the vendor can be informed of such information as the nature of the operations being undertaken, energy use and carbon dioxide production, expense information, and productivity that is currently being achieved, as well as information relating to the needs that must be met by the equipment. For example, information that may be collected includes information relevant to the actions being performed and the items on which the actions are being performed. For example, if products are being handled, characteristics such as the weight, volume, fragility, number of units in a package, size range of units, proportion of units of each size, and other relevant information may be collected. A size range of units may be, for example, the different sizes in which a product may be offered. In the case of pain relievers, 12-tablet bottles, 50-tablet bottles, 100-tablet bottles, 300-tablet bottles, 500-tablet bottles, 750-tablet bottles, and 1000-tablet bottle, and different numbers of these bottles may be boxed together in packages for delivery to stores. A particular quantity of each size of bottle may be filled and packaged during a production day, and information about the characteristics of the items to be handled and the finished products resulting from the handling provides valuable information that can be analyzed to determine how best to handle the items in order to produce the finished products. The customer seeking proposals from vendors may also furnish information relating to its costs of operation, such as the energy consumed and the amount of waste produced in the operations.

Other information, as noted above, includes information relating to items on which operations are to be performed, and may also include supply chain and transaction information. For example, particularly if operations involve transportation or warehousing, frequency and flexibility of delivery, warehouse capacity, demand from customers and variability of that demand, and other factors influence handling of the goods.

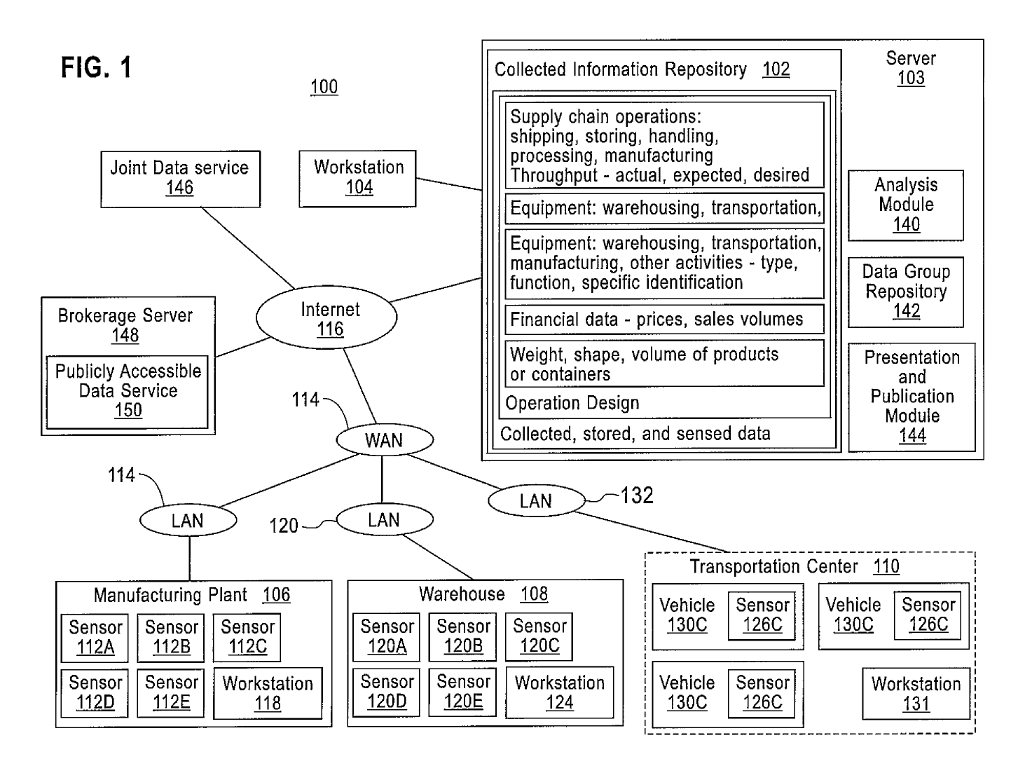

FIG. 1 illustrates a system 100 for gathering and distributing information relating to a process of manufacturing and distribution of goods according to one or more embodiments of the present invention. The system 100 gathers information relating to a process of manufacturing, storing, handling, and distributing goods, with the information being gathered in terms of the results to be achieved and the conditions under which the operations are to be carried out.

The system 100 comprises a collected information repository 102, which may be hosted by a server 103. The collected information repository 102 stores collected, entered, and sensed data of various types and falling into various categories.

One category of information that may be stored in the repository 102 is information that changes relatively slowly, such as customer demand, locations of customers, characteristics of materials to be handled and processed, frequency with which raw materials are received and with which finished goods are delivered, and other information that can be expected to be entered by operators. The system 100 may also comprise one or more workstations such as the workstation 104, which may be used to enter any sort of information but may be more customarily used to enter information that is not solely associated with one aspect of the operation, such as details and parameters for one or more aspects of the operation or for the operation as a whole. For example, a workstation such as the workstation 104, or other mechanisms, may be used to create an overall design or description of an operation. For example, a description of supply chain operations may be created, laid out in terms of, for example, a design plan describing supply chain operations such as shipping, storing, handling, processing, and manufacturing, as well as present and expected or hoped-for supply chain network throughput. Such a description may also include information identifying the equipment being used for warehousing, transportation, manufacturing, and other activities. Information relating to equipment may, for example, include information identifying the type and functions of equipment, and, depending on design choice, may include specific identification of equipment items, such as brand and model identification.

Additional information relating to the overall operations of the organization or aspects of the organization may include information may also include information such as financial data, including prices charged for products, and sales volumes. Additional stored information may include information such as weight, shape, and volume of products or containers. Such information may be entered as part of an overall plan or based on data provided to a central collecting point, entered at locations carrying out operations, or both, and may be updated through manual entry, through extraction of information collected when ordering materials, through sensing, or through any other appropriate mechanisms.

The system 100 may also comprise information gathering devices associated with a manufacturing plant 106, a warehouse 108, and a transportation center 110. The system 100 suitably employs sensors 112A-112E deployed at the manufacturing plant 106, and these sensors may include an energy use sensor 112A, a carbon dioxide sensor 112B, a temperature sensor 112C, a humidity sensor 112D, and a weight sensor 112E. The sensors 112A-112E may all suitably note time information along with their sensing of information relating to conditions and may store the sensed information for later retrieval, forward it to the repository 102, or manage it in any other way desired. In one or more embodiments of the invention, one or more of the sensors 112A-112E communicate wirelessly or over a wired connection with a local area network (LAN) 114. The system 100 may also include one or more workstations such as the workstation 118, allowing entry of details and parameters relating to or desired for the operations being undertaken in the facility, such as billing information for various goods and services, which may include energy, information services, and the like. One particularly useful item of information which may be entered using the workstation 118 is the quantity of variable goods or services, such as energy and repair calls, which may be required.

The system 100 includes sensors 120A-120E in the warehouse 108, and these sensors also communicate with a LAN, in this case the LAN 120, which may provide access to the Internet 116. The system 100 also includes the workstation 124.

The system 100 includes sensors 126A-126C for the transportation center 110, including fuel use and travel sensors 126A, 126B, and 126C for delivery vehicles 130A, 130B, and 130C, respectively. The sensors 126A-126C may include components such as fuel consumption sensors, global positioning system (GPS) receivers, and carbon dioxide sensors. The system 100 may also include a workstation 131 associated with the transportation center 110, which may be used to provide relevant information such as service frequency and use of consumables that are used periodically, such as oil, coolant, and tires, as well as empty weight and laden weight of vehicles. The sensors 126A-126C and the workstation 131 may be connected to a LAN 132. The various information gathering components may communicate with the server 102 directly, or through the LANs 114, 122, and 132, and the LANs 114, 122, and 134 may provide access to a wide area network (WAN) 136 and may, either directly or through the WAN 136, provide access to the public Internet 138. The Internet 138 may be used as a communication medium with the server 103.

The server 103 may suitably include an analysis module 140, which may analyze the various information components collected by the various sensors and entered using the various workstations. The analysis module 132 may identify the operations for which proposals are to be sought, such as proposals relating to transportation operations, warehousing operations, or manufacturing operations, and may further identify information associated with particular changes or improvements that are to be made. For example, in the case of a pain reliever manufacturer, a greater throughput in filling packages of bottles may be desired, but not a greater throughput in filling the bottles themselves. Data relating to this aspect of the operation, then, will include characteristics of the filled bottles but not the characteristics of the tablets or of requirements related to sealing and closing the bottles. On the other hand, it may often be desirable to simply release information relating to all aspects of the operation, on the assumption that equipment providers can better understand how to design, selected, and combine equipment to achieve particular results and that this better understanding can allow them to offer benefits that might not be recognized by a customer that concentrates on carrying out its operations and does not have the time or resources to consider all equipment or service combinations that might improve its operations. Interested vendors might then examine the information, which might allow them to suggest overall improvements or improvements to a single component of the operation or a combination of aspects of the operation. If vendors have access to information that can be used to understand the needs of a customer, they can focus on individual aspects of the customer's operations and perform analysis on those aspects, rather than analyze the entire operation in every case. The more broad-based and complex an analysis needs to be, the more costly it is likely to be for the vendor, and vendors may not wish to undertake comprehensive evaluations of complete operations without a relatively high degree of assurance that they will be requested to supply goods or services needed for the operation.

However, it will be recognized that vendors are free to perform whatever evaluations they wish using information that is made available to them, and they may choose to examine narrower aspects of the operation, particularly those for which they believe they can provide significant improvements.

In any case, the analysis module 140 examines and groups data relating to aspects of the customer's operations and may categorize it so that subsets of information may be made available to vendors. In the example illustrated here, convenient categories are manufacturing, warehousing, and transportation, and further divisions may be performed if desired. The analysis module 140 stores the data in a data group repository 142, which is available to a presentation and publication module 144. The presentation and publication module 136 selects information from the data group repository 142 and makes the information accessible to suppliers that may be able to provide goods or services.

At appropriate times, such as on a periodic schedule, upon identification of a specific need, upon a desired change to a procedure, such as a desire for more efficient energy use or greater throughput, or upon updating of information stored in the repository 102 or in data groups that are specifically identified or identified through conforming to particular criteria, such as association with operational costs greater than a particular percentage of the total. The presentation and publication module 144 selects data from the data group repository 142 and organizes data into a format suitable for presentation to vendors. The data may be directed to specific vendors or may be published so as to be generally accessible or accessible to vendors likely to use the information effectively. In one or more embodiments of the invention, data is anonymized, that is, separated from the identification of the customer providing it. Anonymization may be accomplished, for example, by furnishing the information in association with an anonymous identifier. A vendor may prepare a proposal or request for information and present the request or proposal along with the identifier, presentation of which notifies a customer that the request or proposal is directed to itself. Such an approach allows, for example, through the use of a joint data service 146 shared by a number of customers, to prevent data from being associated with a customer through its appearance on a site that can be traced to the customer. In one or more alternative or additional embodiments of the invention, data may be anonymized through brokering the information through a third party that may, for example, operate a brokerage server 148 that releases the data but not the identity of the customer. The brokerage server may operate a publicly accessible data service 150, which may respond to requests from vendors for data relating to goods or services they may provide, or may generally provide access to identified vendors, and may, on request from a customer, block access to one or more parties in order to protect customer data from access by vendors who are, for example, engaged in relatively close competition with a customer.

Once a vendor has access to the data, it can use its own expertise to determine if and how it can provide improvements to the data furnished by the customer—for example, providing equipment that furnishes greater throughput, that requires less frequent maintenance, that costs less to maintain, that uses less energy or causes less carbon dioxide emission, or that otherwise provides improvement. A customer may, but need not, specify the particular improvements envisioned, and may not have a clear idea that improvements can be made to a particular aspect of the operation. A vendor may submit proposals directly or through a data service such as the data services 142 or 144.

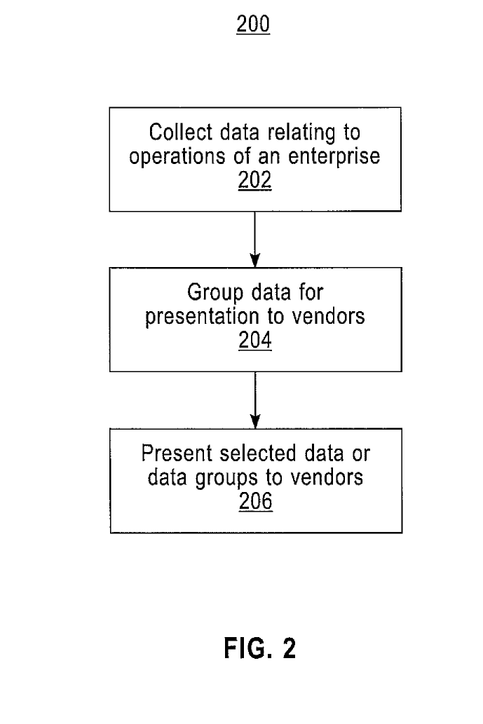

FIG. 2 illustrates a process 200 according to an embodiment of the present invention. At step 202, data is collected relating to the operations of an enterprise. The data may be, for example, data relating to cost, efficiency, and waste relating to the operations, and may also be identified with particular aspects of the operation of the enterprise. At step 204, the data is grouped for presentation to vendors. At step 206, selected data or groups of data are presented to vendors, such as directly to individual vendors or groups of vendors, through publication, through a service providing anonymity, or through a combination of these or other mechanisms.

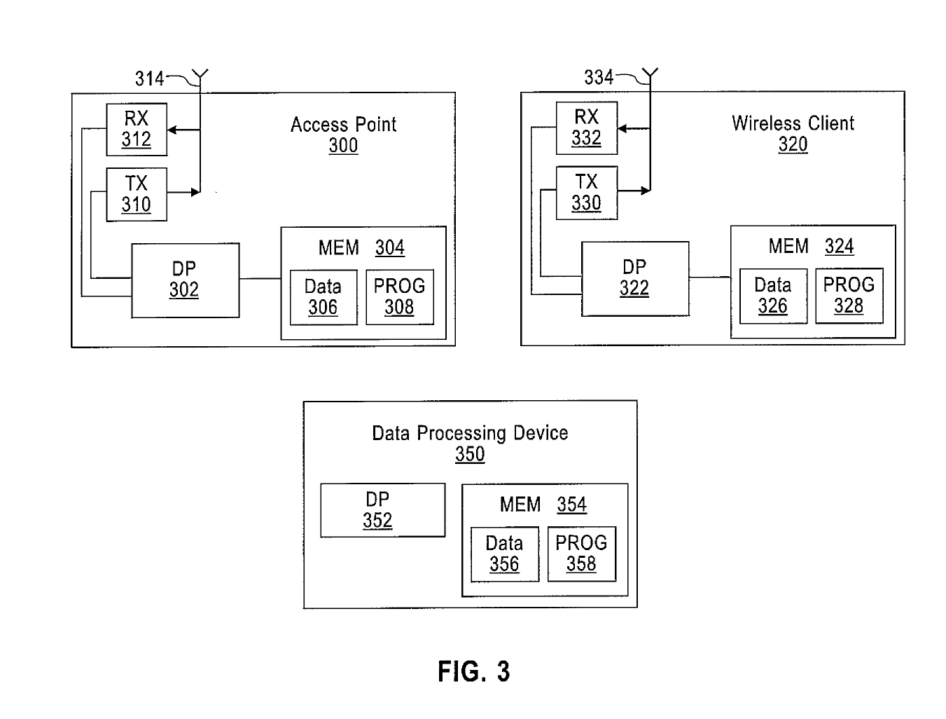

FIG. 3 illustrates an exemplary data processing device 300 according to an embodiment of the present invention. The device 300 may, for example, be implemented as servers, workstations, sensors, LAN components, WAN components, or other devices.

The data processing device 300 comprises a data processor 302 and memory 304, with the memory 304 suitably storing data 306 and software 308. The software 308 stored in memory 304 includes program instructions (software (SW)) that, when executed by the associated data processor 302, enable the user device to operate in accordance with the exemplary embodiments of this invention. That is, the exemplary embodiments of this invention may be implemented at least in part by computer software executable by the DP 302 of the various electronic components illustrated here, with such components and similar components being deployed in whatever numbers, configurations, and arrangements are desired for the carrying out of the invention. Various embodiments of the invention may be carried out by hardware, or by a combination of software and hardware (and firmware).

FIG. 3 illustrates an exemplary wireless client 300 according to an embodiment of the present invention, configured to act, for example, as a sensor, workstation, or other device communicating through a wireless connection.

The user device comprises a data processor 322 and memory 324, with the memory 324 suitably storing data 326 and software 328. The user device 320 further comprises a transmitter 330, receiver 332, and antenna 336. The software 326 stored in memory 324 includes program instructions (software (SW)) that, when executed by the associated data processor 322, enable the user device to operate in accordance with the exemplary embodiments of this invention. That is, the exemplary embodiments of this invention may be implemented at least in part by computer software executable by the DP 322 of the various electronic components illustrated here, with such components and similar components being deployed in whatever numbers, configurations, and arrangements are desired for the carrying out of the invention. Various embodiments of the invention may be carried out by hardware, or by a combination of software and hardware (and firmware).

FIG. 3 also illustrates an exemplary wireless access point 350, allowing communication by wireless communication devices which operated, for example, as part of a wireless local area network or a wireless cellular network, and may, for example, serve as an access point to a local area network or wide area network.

The access point 350 comprises a data processor 352 and memory 354, with the memory 354 suitably storing data 356 and software 358. The access point 350 further comprises a transmitter 360, receiver 362, and antenna 366. The software 366 stored in memory 354 includes program instructions (software (SW)) that, when executed by the associated data processor 352, enable the user device to operate in accordance with the exemplary embodiments of this invention. That is, the exemplary embodiments of this invention may be implemented at least in part by computer software executable by the DP 352 of the various electronic components illustrated here, with such components and similar components being deployed in whatever numbers, configurations, and arrangements are desired for the carrying out of the invention. Various embodiments of the invention may be carried out by hardware, or by a combination of software and hardware (and firmware).

The various embodiments of the wireless client device 320 can include, but are not limited to, cellular phones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The memories 304, 324, and 354 may be of any type suitable to the local technical environment and may be implemented using any suitable data storage technology, such as semiconductor based memory devices, flash memory, magnetic memory devices and systems, optical memory devices and systems, fixed memory and removable memory. The data processors 302, 322, and 352 may be of any type suitable to the local technical environment, and may include one or more of general purpose computers, special purpose computers, microprocessors, digital signal processors (DSPs) and processors based on multi-core processor architectures, as non-limiting examples.

Various embodiments of the present invention improve over the prior art by gathering information relating to various aspects of the operations of an organization and presenting it to parties who may be in the best position to analyze the information to identify and meet the needs of the organization.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

We claim:

1. A method comprising:
collecting data relating to carrying out an operation, wherein data is collected relating to at least one of inputs to and results of the operation, material usage of the operation, and waste produced by the operation; and
making the collected data accessible to one or more vendors providing at least one of products and services relating to carrying out the operation.

2. The method of claim 1, further comprising assembling data into at least two groups, wherein each of the groups is associated with an aspect of the operation.

3. The method of claim 1, wherein the groups comprise at least one of data associated with supply chain management, data associated with product production, data associated with handling of goods, and data associated with transportation.

4. The method of claim 1, wherein the collected data comprises data relating to energy usage in the operation.

5. The method of claim 1, wherein the collected data comprises data relating to carbon dioxide production in the operation.

6. The method of claim 1, wherein the collected data comprises data relating to characteristics of goods handled in the operation.

7. The method of claim 6, wherein the collected data comprises data relating to at least one of weight, shape, and size of goods handled in the operation.

8. The method of claim 1, wherein making the collected data accessible comprises directing the data to at least one vendor.

9. The method of claim 1, wherein making the collected data accessible comprises separating the data from identification of an entity collecting the data.

10. The method of claim 1, wherein making the collected data accessible comprises storing the data using a data service protecting identity information of an entity furnishing the data.

11. A method comprising:
storing data collected from a plurality of organizations, data from each organization relating to carrying out at least one operation of the organization, wherein the data further relates to at least one of inputs to and results of the operation, material usage of the operation, and waste produced by the operation;
separating the collected data relating to carrying out the at least one operation of the organization from identifying data identifying the organization; and
making the collected data accessible to one or more vendors providing at least one of products and services relating to carrying out the operation.

12. The method of claim 11, wherein making the collected data accessible comprises storing the collected data in a publicly accessible repository.

13. The method of claim 11, further comprising, upon receiving proposal information from a vendor relating to data collected from an organization, associating the collected data with the organization from which the data was collected and forwarding the proposal information to the organization.

14. The method of claim 11, wherein making the collected data accessible comprises associating the collected data from each organization with an anonymous identifier.

15. A method comprising:
collecting data relating to carrying out an operation, wherein data is collected relating to inputs to and outputs of the operation, energy usage of the operation, and carbon dioxide production of the operation, wherein the collected data comprises data relating to characteristics of goods handled in the operation, and wherein data relating to the characteristics of goods comprise data relating to at least one of weight, shape, and size of goods handled in the operation;
assembling data into at least two groups, wherein each of the groups is associated with an aspect of the operation, and wherein the groups comprise at least one of data associated with supply chain management, data associated with product production, data associated with handling of goods, and data associated with transportation; and
making the collected data accessible to at least one vendor providing at least one of products and services relating to carrying out the operation.

16. The method of claim 15, further comprising receiving vendor information from the at least one vendor, wherein the vendor information recommends at least one of products and services for carrying out the operation, and wherein the recommendation is based on analysis by the at least one vendor of the collected data made accessible to the vendor.

17. The method of claim 16, wherein the vendor information comprises at least one recommendation directed to improving efficiency of the operation.

18. The method of claim 17, wherein the vendor information comprises at least one recommendation directed to reducing energy usage in the operation.

19. The method of claim 16, wherein the vendor information comprises at least one recommendation directed to reducing waste produced by the operation.

20. The method of claim 19, wherein the vendor information comprises at least one recommendation directed to reducing carbon dioxide produced in the operation.
